(19) United States
(12) Patent Application Publication
(10) Pub. No.: US 2022/0076332 A1
(43) Pub. Date: Mar. 10, 2022

(54) SYSTEM FOR DIRECTED CONDITIONAL INDICATION OF INTEREST (IOI) MESSAGING

(71) Applicant: Bids Trading, L.P., New York, NY (US)

(72) Inventors: Timothy J. Mahoney, New York, NY (US); Robert Burns, New York, NY (US); Sik Ngai, Calgary (CA); Adel Sarhan, New York, NY (US); Brett Vasconcellos, Calgary (CA)

(21) Appl. No.: 17/321,816

(22) Filed: May 17, 2021

Related U.S. Application Data
(60) Provisional application No. 63/075,076, filed on Sep. 4, 2020.

(51) Int. Cl. G06Q 40/04; H04L 12/58

(52) U.S. Cl. CPC G06Q 40/04; H04L 51/08

(57) ABSTRACT

An intermediary system, between broker and client systems receives, from the broker system, an electronic message including an indication of interest (IOI) to execute a trade. The intermediary system identifies an interest of a trader in the trade of the IOI and routes the electronic message to the trader's client system. The identified interest is undisclosed by the trader to the broker and intermediary systems but is inferred based on the trader's trading activity (e.g., the trader's blotter data). The intermediary system routes the electronic message including the IOI to the client system and responds to an indication that the trader triggered an action at the client system to execute the trade by causing the order to fill.

### CROSS-REFERENCE TO RELATED APPLICATION

This application claims priority to and benefit from U.S. Provisional Patent Application No. 63/075,076, titled “Directed Conditional Indication of Interest,” and filed on Sep. 4, 2020, which is incorporated herein by reference for all purposes.

### BACKGROUND

An electronic trading platform includes a software program operating on a computer system that enables users to place orders for trades over a computer network with an intermediary, or directly between users (e.g., traders). The trades can include stocks, bonds, currencies, commodities, and derivatives. Examples of intermediaries include brokers, market makers, investment banks, or stock exchanges. A trading platform can stream live market prices on which users can trade, and can provide trading tools such as charting, news feeds, and account management. Users submit orders to buy/sell a quantity of a financial product to the trading platform which, in turn, uses order matching algorithms to execute trades based on the orders. Following execution of the trades, a clearing and settlement process exchanges the seller's financial products for the buyer's money.

Various online platforms can include standard messaging functions (e.g., instant messaging, direct messaging, email). A direct message (DM) is a private communication between users. In one example, social media networks for public posting such as Twitter®, Facebook®, and Instagram® include private chat functions. In another example, messenger apps such as WhatsApp® or Snapchat® are configured primarily to exchange DMs. In yet another example, peer-to-peer messaging gives users control over the data they transmit and store between users. While a trading platform can include messaging functions, there capabilities are limited and fail to address the challenges of asymmetric information found in financial markets, which limits their usefulness in trading securities.

### BRIEF DESCRIPTION OF THE DRAWINGS

Embodiments of the present technology will be described and explained through the use of the accompanying drawings.

FIG. 1 is a block diagram that illustrates an electronic trading environment.

FIG. 2 is a block diagram that illustrates a system for processing electronic messages of an electronic trading environment.

FIG. 3 is a high-level illustration of a workflow for an indication of interest (IOI).

FIG. 4 is a high-level illustration of a workflow for a conditional IOI.

FIG. 5 is a flow diagram that illustrates an actionable IOI message workflow,

FIG. 6 illustrates a user interface (UI) that displays blotter data and IOI data.

FIG. 7 is a block diagram of an example machine implementing a system for processing IOIs communicated between users of an electronic trading platform.

The technologies described herein will become more apparent to those skilled in the art from a study of the Detailed Description in conjunction with the drawings. Embodiments are illustrated by way of example and not limitation in the drawings, in which like references can indicate similar elements. While the drawings depict various embodiments for the purpose of illustration, those skilled in the art will recognize that alternative embodiments can be employed without departing from the principles of the technologies. Accordingly, while specific embodiments are shown in the drawings, the technology is amenable to various modifications.

### DETAILED DESCRIPTION

The disclosed technology addresses inefficiencies in messaging systems to manage asymmetric interests in maintaining information undisclosed, particularly in electronic platforms that provide communications between multiple users. As used herein, a directed conditional indication of interest (IOI) refers to a method of messaging in which an IOI is communicated in an electronic message over a network to an intermediary system that implements a conditional workflow, which directs an IOI message to a targeted user that has an identifiable interest in receiving the IOI. An IOI conveys a non-binding interest in transacting a trade in a financial market. As such, IOI messages allow participants to query an interest for buying or selling a security in the market without having to place visible orders on an order book.

The disclosed technology can be incorporated into an electronic platform that interconnects users having different roles, which designates and restricts interactions under a common management protocol. For ease of understanding, the disclosed technology is described herein mainly in the context of an electronic trading environment of, for example, a securities market. As such, terms commonly used in electronic trading technology are used herein to describe implementations.

In one example, a trading platform enables users to place buy or sell orders over a computer network through the intermediary system. For example, a user that is designated as a broker can carry one or more positions in one or more individual securities on the trading platform. In practice, the broker has a variety of tools and methods for exiting or hedging a position. One method includes using a commercial messaging system to communicate IOIs to a broadest possible audience of potentially interested traders. The messaging system can use or be integrated into the trading platform to communicate electronic messages that include IOIs, which are broadcast to a group of users of the trading platform. Thus, an IOI message is intended to notify potential counterparties that a broker wishes to trade a specific security and invites the counterparties to contact the broker to agree to terms of the IOI.

The conventional IOI messaging process has two fundamental inefficiencies. First, from a sender's perspective, disclosing a position is potentially detrimental because others can discern the sender's trading intentions. In particular, the sender generally prefers to minimize disclosing information about a trading intention. That is, the sender prefers to only send out minimal information of the position to only a minimal number of recipients, more preferably only one recipient. However, without at least some degree of disclosure, the sender cannot alert any potential counterparties. Hence, a risk of disclosing too much information to too many parties always exists. Second, recipients that are targeted for IOI messages encounter related inefficiencies. A typical recipient includes an institution, a fund manager (e.g., a mutual fund), hedge fund, or any other client of a broker. A recipient seeks to avoid receiving too many IOI messages that are irrelevant to the recipient's portfolio. Instead, a recipient prefers to receive fewer IOI messages, only for trades of interest to the recipient, and only from brokers that the recipient trusts.

The disclosed directed conditional IOI messaging process solves the drawbacks of prior systems by sending IOI messages only to recipients that have identifiable interests in receiving the IOI messages and, accordingly, limits viewable IOI messages received by the recipients. The interests are inferred without needing explicit disclosures between senders and recipients of the IOI messages. Moreover, recipients only receive IOI messages from trusted senders and the senders only send IOI messages to trusted recipients. As such, the disclosed technology reduces the inefficiencies of prior systems that implement a shotgun approach of broadly broadcasting an IOI to identify a user that may be interested in receiving the IOI. Further, the disclosed technology reduces the risk of disclosing too much information to too many users, thereby unintentionally impacting markets.

In one implementation, an intermediary system in a trading environment supports a network of users (e.g., brokers, clients). The system uses or includes a messaging system that supports a directed conditional IOI message workflow. Any of the users can opt-in to a directed conditional IOI messaging service. The disclosed technology includes a variety of other optional enhancements such as a single-click immediate execution or trade against an IOI (e.g., following negotiation, if necessary), facilitating a commission payment between users, and additional techniques of score-carding or filtering to target recipients, optimizing interactions, and preventing gaming or other abuses.

The disclosed technologies thus improve the performance of messaging systems, particularly for trading platforms, by repurposing data from another unrelated system to manage whether and what messages are communicated between users to thereby avoid unnecessary disclosures. An objective of the disclosed technology includes minimizing the number of messages and amount of content distributed over computer networks. Messages are targeted in terms of recipients and content such that only users that indicated an interest in receiving the messages will receive those messages, and recipients only see the messages that interest them. As such, the targeted messaging improves performance of computer networks due to a reduction in network traffic and congestion.

Likewise, the disclosed technologies reduce latencies when communicating messages by decreasing network traffic and to execute on those messages from a common platform in a standardized format. Specifically, a unified computer interface presents the messages and can receive input to execute on those messages. As such, the disclosed technology obviates the need to run multiple separate applications with different displays concurrently presented on the same computer screen. Instead, a single interface can both present a message of interest and enable execution on that message.

Additional techniques are described in the assignee's related patents including U.S. Pat. No. 10,769,725, filed Jun. 5, 2014, titled “Electronic Block Trading System and Method of Operation” and U.S. Pat. No. 8,380,612, filed Jan. 27, 2011, titled “System and Methods for Optimizing the Effectiveness of Interaction Between Participants in an Electronic Trading Environment,” each of which are incorporated by reference in their entireties for all purposes.

Various examples of the disclosed technology are described herein. The description provides specific details for a thorough understanding and an enabling description of these examples. One skilled in the art will understand, however, that the examples may be practiced without many of these details. Additionally, some well-known structures or functions may not be shown or described in detail, so as to avoid unnecessarily obscuring the relevant description of the various examples. The terminology used in the description presented below is intended to be interpreted in its broadest reasonable manner, even though it is being used in conjunction with a detailed description of certain specific embodiments.

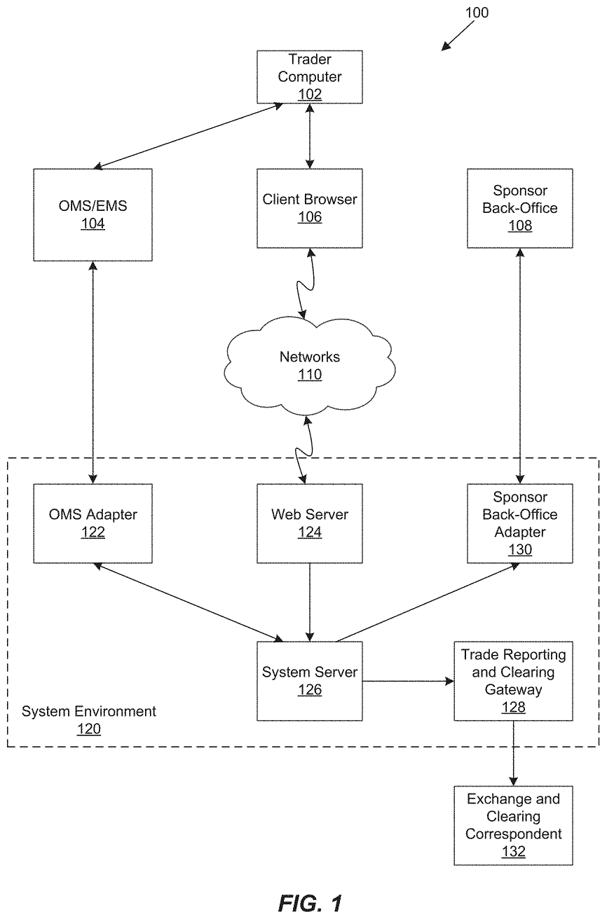

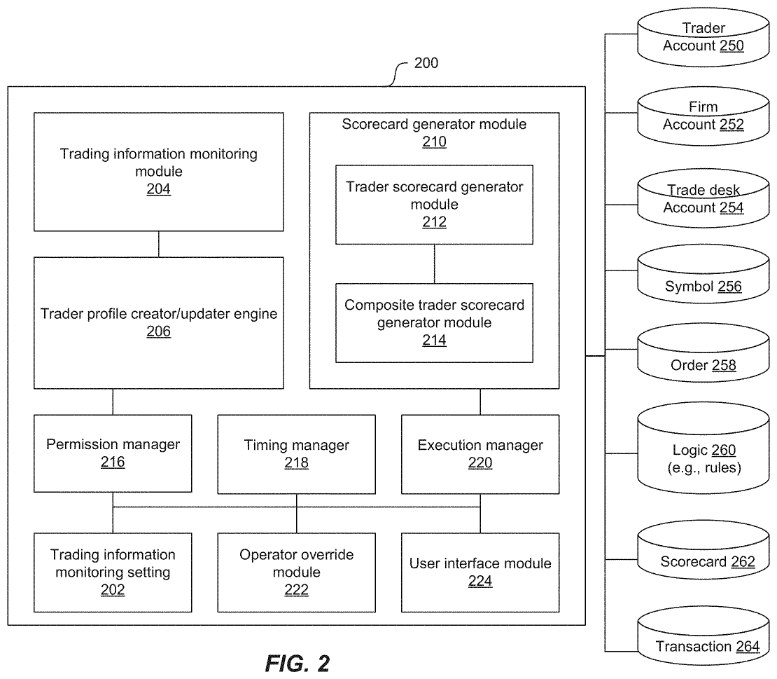

FIG. 1 is a block diagram that illustrates an electronic trading environment. In one example, a trader computer 102, whether for a buy side trader or a sell side trader, accepts one or more orders into the system environment 120. In one implementation, the trader computer 102 receives orders using a browser 106 on a client or terminal device such as a desktop computer, a laptop computer, a work station, a mobile device, a tablet, and the like, that is connected via a network 110 to a web server 124. The network 110 can include a wireless, wired, or any other type of network. The communication between the client or terminal device and the web server 124 via the network 110 is secured and/or encrypted. In another implementation, the trader computer 102 can enter orders via a buy-side or sell-side trading system order management system (OMS) or execution management system (EMS) 104.

An example of an OMS includes a software-based platform that facilitates and manages order execution of securities, typically through the FIX protocol. OMS systems are used on both buy-side and sell-side, although the functionality provided by buy-side and sell-side OMS differs. Typically, only exchange members can connect directly to an exchange, which means that a sell-side OMS usually has exchange connectivity, whereas a buy-side OMS is concerned with connecting to sell-side firms.

An example of an EMS includes an application utilized by traders designed to display market data and provide seamless and fast access to trading destinations for the purpose of transacting orders. This application contains broker provided and independent algorithms such as TWAP and VWAP, global market data, and technology that can help predict certain market conditions. An important feature of an EMS is a capacity to manage orders across multiple trading platforms such as stock exchanges, stock brokerage firms, crossing networks and electronic communication networks.

As shown, the OMS/EMS 104 is connected to the OMS adapter 122 directly or via the network 110. The OMS adapter is used to communicate or translate transactions and responses between traders in the system environment 120. In one example, orders that are transmitted to the system environment 120 by from trader computer 102 via the OMS/EMS 104 or the web browser 106 are sent to system server 126 for processing the order according to the rules of the system. When trades are initiated, information about the trades, besides being sent to the counterparties to the transaction, is forwarded to the trade reporting and clearing gateway 128 and sponsor back-office adapter 130.

The trade reporting and clearing gateway 128 transmits trade reports of exchange and clearing files to a clearing correspondent. In one example, an exchange and clearing correspondent 132 reports the trades out to the market and the clearing correspondent, which clears and settles the trades. The sponsor back-office adapter 130 transmits trade and order information to a sponsor back-office 108 for record keeping. This information may include, but is not limited to, trade and order details.

Fla 2 is a block diagram that illustrates a system for processing electronic messages of an electronic trading environment. As illustrated, the system 200 monitors and tracks certain information (e.g., variables) at several levels (e.g., broker, firm, trader, trade desk, symbol, side, order type) for each participant (e.g., users such as brokers and their clients) in the system 200. The system 200 updates values associated with the tracked variables in real-time, and/or over longer periods of time. In one example, based on the values of the variables, the system 200 assigns individual and/or composite scores to each trader, symbol, side of a transaction, or any combination thereof. For an interaction (e.g., IOI messaging) in the trading environment, a comparison of individual scores or composite scores and variables are used to determine whether or how counterpart users are allowed to interact.

The system 200 may include several components, engines, and/or modules. As used herein, a “module,” a “manager,” or an “engine” includes a general purpose, dedicated, or shared processor and, typically, firmware or software modules that are executed by the processor. Depending on specific implementation or other considerations, the module, manager, or engine can be centralized or distributed. The module, manager, or engine can include general or special purpose hardware, firmware, or software embodied in one or more computer-readable storage mediums for execution by the processor.

As shown, the system 200 can include a trading information monitoring setting module 202, a trading information monitoring module 204, a trader profile creator/updater engine 206, a scorecard generator module 210 having a trader scorecard generator module 212 and a composite trader scorecard generator module 214, a permission manager 216 for receiving/sending messages to, a timing manager 218 for receiving/sending messages, a trade execution manager 220, a user interface (UI) module 224, and an operator override module 222. One or more of these modules may be consolidated into a single module or sub-divided into multiple modules in some implementations.

The trading information monitoring setting module 202 can be used to define, select or specify information (e.g., one or more variables) for monitoring by the trading information monitoring module 204. Examples of the variables relate to trader behavior, order type, size information, and the like. Monitoring, tracking, and analyzing of one or more of the variables can provide an insight into trader behavior, in real time, over a time period, and changes or trends in trader behavior, for example.

The trading information monitoring module 204 monitors and tracks selected variables at several levels for each participant in the system. The trading information monitoring module 204 captures values corresponding to the monitored variables and stores the values for each trader in a datastore. The trading information monitoring module 204 can further update values associated with the variables in real-time and/or over longer periods. In one implementation, the trading information monitoring module 204 monitors the variables universally (e.g., for all orders), and/or for orders matching certain criteria. In another implementation, the trading information monitoring module 204 monitors variables for specific symbols on a trader's blotter.

A “blotter,” as used herein, refers to a record of trades and details of trades made over a time period (e.g., a trading day). The details of a trade can include the time, price, order size, and a specification of whether it was a buy or sell order. The blotter is usually created through a trading software program that records the trades made through a data feed.

The trader profile creator/updater engine 206 can create a profile for each trader by using information of variable(s) captured and stored by the system 200, and/or other information derived from the analysis of captured data. The trader profile is updated and/or supplemented over time as more information is available from the monitoring, or other sources (e.g. from the scorecard generator module 210).

The scorecard generator module 210, having a trader scorecard generator module 212 and a composite trader scorecard generator module 214, can perform scorecard calculations to generate a score based on information of one or more monitored variables. The scorecard calculation can be on a trader basis, symbol basis, based on trading desk transactions, or the like. The score can be a statistical score, generated using statistical methods such as averages, medians and/or more complex statistical methods. In a further implementation, the score can be generated as a weighted sum, average or other formula that assigns more weight or importance to certain variables and less weight or importance to others.

The trader scorecard generator module 212 generates a score for each trader across all orders based on trader behavior information and/or other information obtained from monitoring variables. The individual trader scorecard can be calculated for orders matching certain criteria (e.g., time criteria, order type criteria, and the like). The composite trader scorecard generator module 214 can generate a composite score for trader per symbol, a composite score for trader per symbol per side, and the like. The scorecards generated by the scorecard generator module 210 can be stored in association with the trader profile. The scorecard can be recalculated or updated as new information is available from the monitoring module 204.

A comparison of respective individual or composite trader scores for variables can be used to determine whether and how counterpart users are permitted to interact. For example, a comparison of respective scores can be used to determine (a) permission and timing for sending an IOI message, (b) permission and timing for receiving or viewing IOI messages, and (c) an execution based on an IOI message. In one embodiment, the logic for triggering these interactions are configured via the modules 216-220.

In general, the permission manager 216 filters IOI messages sent to the system 200 such that only traders that satisfy certain rules or conditions can receive (e.g., access, view) certain IOI messages and traders that do not satisfy the rules and/or conditions are blocked from the IOI messages. The permission manager 216 operates based on logic (e.g., conditions, rules) to send or receive IOI messages, target users, and execute against an IOI message. For example, the permission manager 216 can control whether IOI messages are sent or received by users. In another example, the permission manager 216 can implement a rule to change a conditional order (an order in which volume has not been committed) to a firm order (an order in which volume has been committed) so that the order can be traded in accordance with an IOI message.

In one example, the permission manager 216 allows individual users to configure conditions or rules for filtering IOI messages or to start a negotiation based on a counteroffer that is within a tolerable price or volume range. In another example, the permission manager 216 can permit only traders with trader scores above a predefined threshold to receive certain IOI messages. In yet another example, an IOI message is accessible when a score for a symbol associated with the order is within a predefined range. Various other rules and/or conditions are within the scope of the disclosure.

The timing manager 218 is configured to determine a time to send, receive, or execute on an IOI message to, for example, change a conditional order to a firm order or to start an associated negotiation based on a trade in an IOI message. The time can be determined based on an individual/composite trader scores and/or variables. In one implementation, the timing manager 218 can accelerate or delay receiving or sending IOI messages based on the individual/composite trader scores and/or variables.

The trade execution manager 220 is configured to determine whether a trade execution can occur between counterpart traders based on, for example, the individual/composite trader scores and/or variables. The trade execution manager 220 can also determine a time to execute a trade of an IOI message.

The operator override module 222 allows human operators to intervene and override system logic, trader scores, or system settings. For example, a human operator can use the override module 222 if doing so is in the best interest of participants.

The UI module 224 can generate and/or administer a UI or components thereof. The UI module 224 can be configured to render different interfaces that present data along with controls and menus based on one or more of the modules 202-222 described earlier. As such, the user can interact with the UI in accordance with different processes of a trading environment.

In one implementation, the system 200 is coupled to one or more database tables or datastores such as a trader account table 250 that stores trader information (e.g., trader ID, trader score, trader type), a firm account table 252 that stores firm information (e.g., firm ID, firm name, max order value, daily maximum on sells), a trade desk account table 254 that stores trade desk information (e.g., desk ID, desk name, firm ID, desk type, desk state), a symbol table 256 that stores symbol information (e.g., symbol, firm ID, allow short sell, current volatility, implied volatility), an order table 258 that stores order information (e.g., order ID, order type, entry date/time, price, order size)_{;} a logic table 260 that stores, for example, rule information (e.g., rule ID, condition, outcome), a scorecard table 262 (e.g., trader ID, score value, number of transactions, date range), a transaction table 264 (e.g., transaction ID, order ID, trader ID, symbol ID) and/or other tables. In one implementation, the values corresponding to the monitored variables is stored in one or more the tables 250-262 or in a separate datastore. The way in which a variable is stored and used can differ from one variable to another.

Directed Conditional IOI Messaging

An IOI message is analogous to an electronic advertisement, which is communicated from brokers to their clients. Some IOI messages originate with brokers while others are sent by brokers on behalf of clients to other clients. A broker communicates an IOI message over a network to one or more clients and, if a client accepts a trade of the IOI, the broker is paid a commission. When the client accepts the trade (e.g., a match), the broker is invited to “firm up,” giving it the opportunity to confirm the IOI, which changes a conditional order to a firm order.

An actionable IOI is associated with a function that allows a recipient to execute an action. For example. an IOI message can be associated with a control such as a button that is presented on a trader's UI. When a recipient clicks the button, a message is automatically routed back to the broker to execute the trade of the IOI. Here, there is a preexisting understanding that the broker has the authority to execute the trade in response to automatic response. In contrast, non-actionable IOI messages require a recipient to manually enter terms of the trade into a system that routes a message back to the broker.

Oftentimes, a system on which the IOI message is communicated is different from a system on which the response is routed back to the broker. That is, the IOI and associated messages are communicated between brokers and clients through different systems. In one example, IOI messages are routed from broker systems to a proprietary platform (e.g., Bloomberg), which broadcasts the IOI messages to clients. A client must manually input data in another system to accept a broker's trade. In another implementation, the IOI messages and responses are communicated using a common system. For example, a client can partner with an OMS, which is accessible on the client system, so that IOI messages are delivered through the OMS. In another example, an EMS can automate a response to execute a trade of an IOI message, depending on how the EMS is configured.

Clients normally have preexisting agreements with their brokers, including an understanding to select certain types of IOI messages for the clients. As such, brokers can implement rules to filter IOI messages for clients. For example, the broker can select from among multiple IOI messages to send certain IOI messages to certain clients based on rules that indicate interests of clients. As described in greater detail below, the filters are configured manually or automatically to enforce rules for selecting IOI messages that are of interest to certain clients.

The disclosed solution includes messaging technology for a system (e.g., system 200) that operates as a trusted intermediary between brokers and clients to filter and route IOI messages to clients based on identified interests. In one implementation, the system is OMS/EMS agnostic in order to provide a common experience on different platforms. As such, brokers can send IOI messages to provide a common experience to clients on the different platforms. In addition, the system includes a “page view” function to aggregate click data and/or log instances that clients view or execute on IOI messages. For example, the messaging system can detect whether a recipient viewed or did not view and/or responded or did not respond to a received IOI message. The page view data is indicative of an individual user's activity. The page view data is aggregated by the intermediary system and the aggregate data can be fed back to the broker that sent the IOI message or fed back to the messaging system to update filter logic. In one example, the aggregate data de-identifies individual users. In addition, the page view data can be used to build a scorecard for a trader, which can be used to generate the aggregate reporting to measure information leakage and improve workflows

For example, the messaging system can create filters to block certain types of IOI messages from traders that historically do not view or respond to those types of IOI messages, thereby limiting unnecessary disclosure of information. Thus, interactions with IOI messages (or a lack thereof) allows the system to program filtering logic based on, for example, whether traders viewed messages, a frequency of viewing, the time spent viewing, whether traders performed particular action (e.g., responded to messages), and the like.

The disclosed technology is fundamentally different from conventional advertising services that broadcast to a broadest possible audience and merely count views but do not track who, when, and how long advertisements are viewed or whether users respond to them. Instead, the disclosed technology limits disclosing information while improving the rate of matching traders with IOI messages without bombarding the traders with undesired IOI messages. Further, unlike prior systems, brokers can track IOI messages that are communicated to traders.

Accordingly, the disclosed technology addresses the asymmetry of interests of brokers and traders. For example, consider two sets of IOIs, A and B. Set A represents all IOIs that a broker communicates to traders. Set B represents all IOIs that a trader is interested in receiving. The broker wants to communicate IOIs to as many interested traders but without disclosing more information than necessary. On the other hand, traders only want to receive IOI messages that they are interested in and do not want to inquire with the brokers whether they have any active IOIs of interest. Accordingly, an overlapping subset of sets A and B contain only those IOIs that share a common interest with both the broker and trader.

Moreover, brokers seek to anonymize their interests such that information is only exchanged when both parties have common interests. Moreover, in existing systems, on the broker side, IOI messages are fixed (e.g., common format) and, on the trader side, IOI messages are proprietary (e.g., trader-specific format), and responses are sent from traders to brokers over systems that are separate and distinct from the systems used by the brokers to send IOI messages.

In one implementation, the system filters IOI messages based on orders/symbols in a trader's blotter that are related to orders/symbols of trades indicated in the IOI messages. As such, the interest of a user is inferred from the content of the user's blotter. The identified interest is used to filter the IOI messages that will be presented to the user in a UI along with the blotter entries. Thus, the system repurposes the data of the blotter to manage whether and what messages are distributed over a computer network to direct those messages toward fewer participants. As such, performance of the messaging system is improved based on data of another unrelated system (e.g., the blotter system).

Further, the system provides generic integration in OMS/EMS such that recipients of actionable IOI messages can respond through the same systems on which the IOI messages were received. In other words, the disclosed technology enables receiving and responding to IOI messages through a common platform and integrates actionable functions into that platform. As such, a trader does not have to input data into a separate system to respond to IOIs. The actionable function leverages presence on a trader's desktop application to streamline execution of IOI messages. By delivering IOI messages directly to a trader via the desktop application, the trader can take immediate action with fewer steps (e.g., a single click of an actionable button).

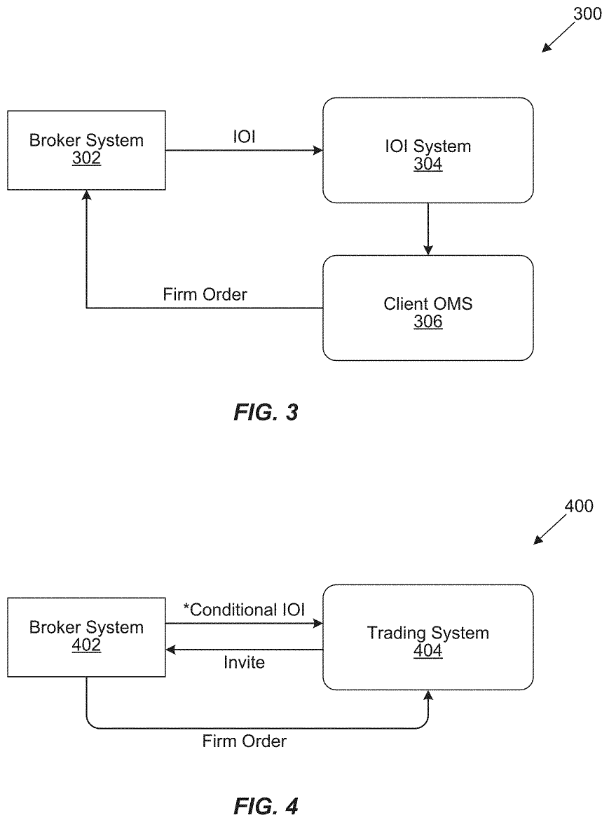

FIG. 3 is a high-level illustration of a workflow 300 for an IOI. As shown, a broker system 302 communicates an IOI message to an IOI system 304 (e.g., Bloomberg® IOIA). The IOI message sent from the broker system 302 can be accompanied with a list of clients selected to receive the IOI message. The IOI system 304 communicates the IOI message to the listed clients including client OMS 306. If interested in the trade indicated in the IOI message, the client OMS 306 sends a firm order to the broker system 302 thereby accepting the terms of the IOI message. The distribution of the IOI message in the workflow 300 is inefficient because recipient clients may or may not have an interest in receiving the IOI messages. Further, the broker system 302 loses track of the IOI message.

Moreover, existing techniques require two separate systems to execute a trade. One system routes an IOI message while another system executes a trade based on the IOI message, which involves switching between applications and multiple interactions (e.g., clicks). Moreover, a broker only has data that an IOI message was sent to a client but is unable to determine if the IOI message was viewed by the client. In contrast, in the disclosed technology, an IOI message is received and executed on a common UI with as little effort as a single click. As such, the disclosed technology improves the efficiency of order entry because there is no need for multiple screens or excessive clicks, and creates a feedback loop with activity data responsive to received IOI messages.

FIG. 4 is a high-level illustration of a workflow 400 for a conditional IOI. Unlike the workflow 300, a conditional IOI message involves a two-step process to complete execution of an IOI message. The “conditional” aspect of the IOI message refers to delaying commitment by the broker system 402 until after the trading system 404 accepts the trade of the IOI message. As shown, the broker system 402 communicates the conditional IOI message to a trading system 404. Once accepted, the trading system 404 communicates an invitation to the broker system 402 to commit to the IOI. The broker system 402 can then communicate a message for the trading system 404 to firm up.

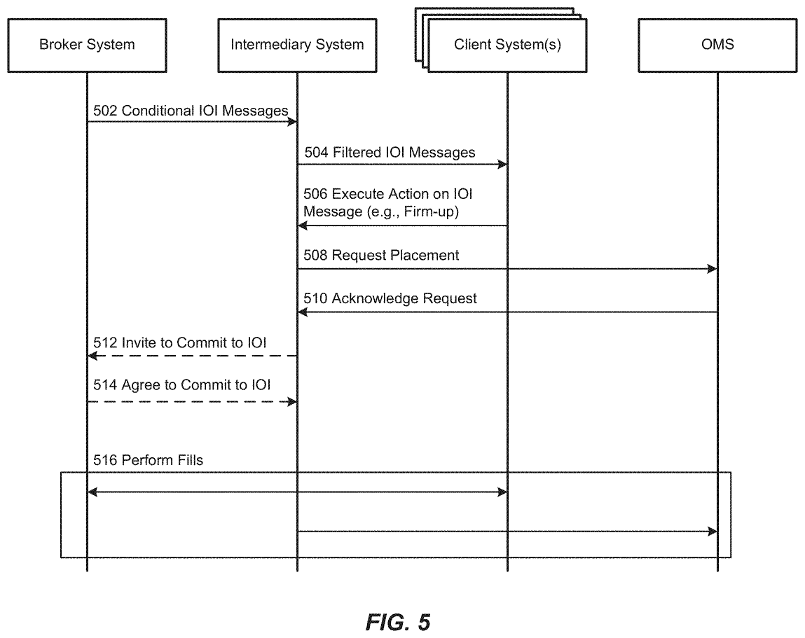

FIG. 5 is a flow diagram that illustrates an actionable IOI message workflow. More specifically, the workflow 500 illustrates a process performed by an intermediary system to filter IOI messages received from a broker system and route the filtered IOI messages to client systems of traders that have identified interests in receiving the filtered IOI messages. The actional functions enable the traders to directly execute on the filtered IOI messages through the intermediary system.

At 502, the broker system communicates one or more IOI messages for the intermediary system. In one example, an IOI message is accompanied by a list of the broker's clients that are identified as eligible targets for the IOI message. The broker system can add one or more tags to each IOI message, which indicates to the intermediary system an attribute of the IOI message. The attribute can be used by the intermediary system to filter the IOI message from among multiple IOI messages and select suitable clients from the client list to receive the IOI message. An IOI message includes trade data such as an order including a quantity of shares for a security that a trader seeks to trade with another trader at a price. In some implementations, the IOI is conditional because the broker commits to the trade only after a trader commits.

At 504, the intermediary system filters the IOI messages for a subset of the clients that have identified interests in receiving the filtered IOI messages. The IOI messages are filtered based on system logic including, for example, rules, criteria, and/or conditions that specify attributes, eligibility requirements, or preferences of brokers or traders. In one example, any trader that satisfies rules/criteria associated with an IOI message is selected to receive the IOI message and any trader that does not satisfy the same rules/criteria is forbidden from receiving the IOI message.

As such, the intermediary system filters IOI messages for recipients such that there is an increased likelihood of matching an IOI message with an interested client, thereby reducing the likelihood of disclosing too much information to too many traders. Upon receipt of the IOI message at a client system of a selected trader, the trader can view the IOI message and execute on it by, for example, clicking on a graphical control button to respond directly to the IOI message and automatically route a message back to the broker system.

The system logic can implement global system rules and/or user-specified rules. An example global rule limits recipients of a broker's IOI message only to the broker's clients. Another example global rule limits receipt of an IOI message only to recipients that permit receipt of specific or any IOI message. The system logic can operate like one or more filters that define a type or class of IOIs and/or include attributes such as pricing information (e.g., whether a stock is tradable based on user preferences, and whether a trade is permitted outside a range for a variable). Thus, IOI messages are mapped to client systems based on the system logic to improve the likelihood of matching interests in respective trades.

Examples of user-specified rules include a broker rule set by a client to specify a minimum volume or price range of an acceptable trade, and a client rule that sets a maximum number of IOI messages for receipt. In some implementations, a user can set one or more preferences or change one or more default settings of the system logic. For example, a user can configure a rule to receive IOI messages including trades that mirror all or only some blotter entries at the client system. In other examples, a user can configure a rule to receive IOI messages including trades that mirror only the active trades 606 but not the inactive trades 608 in a blotter or configure a rule to only receive IOIs including trades that mirror both the active trades 606 and the inactive trades 608 in the blotter. More generally, only traders that have an active identifiable interest in IOIs will receive the corresponding IOI messages, in one example. In another example, any trader with a prior identifiable interest (e.g., based on historical data or a pattern of blotter entries) in a trade of an IOI will receive the corresponding IOI message. As such, the intermediary system matches IOIs for traders based on blotter data, which is used to infer the trader's interests. Other examples include a rule to communicate a standard class of IOIs, or a rule to receive IOIs only from selected brokers or all brokers, or a rule to set a price preference for trades (e.g., midpoint or better, inside a range, outside a range), which can be selected from a menu of levels to tag an IOI message and to set a rule.

In another example, the system logic implements a scoring technique as described earlier to route IOI messages for particular traders that satisfy a threshold individual/composite score and/or variables. In one example, a trader score is based on a frequency or duration of viewing IOIs presented to a trader. In another example, a trader score is based on a quantity of times that a trader accepted or declined trades. For example, a scorecard generator module generates a lower score for a trader that historically fails to respond to IOIs and/or fans to view received IOIs. As such, the trader is unlikely to be selected for receiving IOIs in the future.

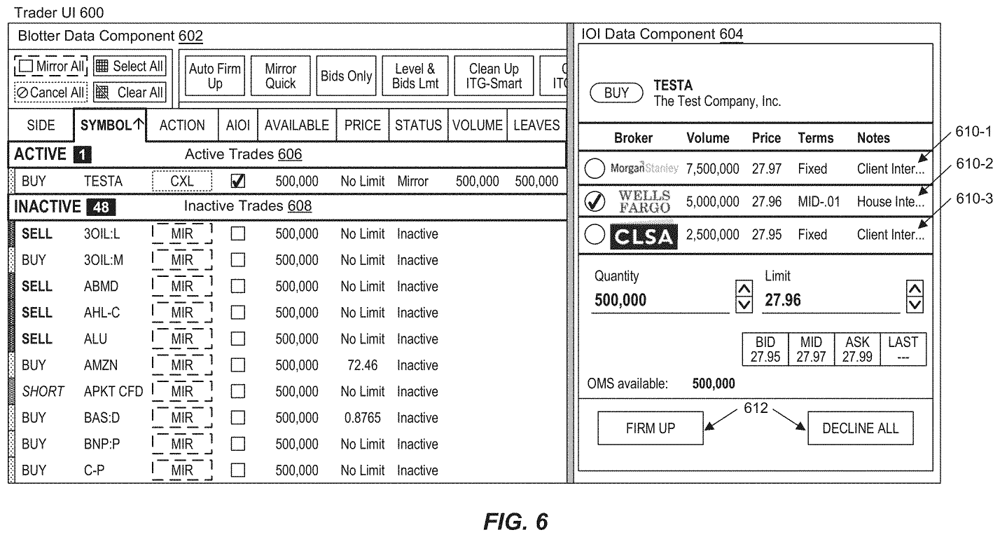

FIG. 6 illustrates a user interface (UI) that displays blotter data and IOI data. A trader UI 600 includes a blotter data component 602 and an IOI data component 604. The blotter data component 602 includes areas for presenting active trades 606 and inactive trades 608. The blotter data component 602 includes records of trades and details collected over a time period (e.g., a trading day). The details of a trade can include a time, price, order size, and a specification of whether the trade was a buy or sell order. As shown, the trader has only one active trade and 48 inactive trades.

The intermediary system can analyze content of the blotter data component 602 to infer the trader's interests that match active IOIs. In one implementation, the trader UI 600 is administered by the intermediary system and concurrently presents the IOI data component 604. In another implementation, the intermediary system partners with the OMS/EMS, which administers the trader UI 600 to concurrently present the IOI data component 604. The trader of the client system can opt-in with the OMS/EMS to concurrently present the IOI data component 604. As such, the intermediary system can generate logic for filtering IOI messages based on content of the blotter data component 602. In one example, blotter data is scraped from the OMS/EMS by the trader UI system and monitored. When an IOI message is received by the trading system, and content of the IOI message matches a blotter entry based on symbol, side, national best bid and offer (NBBO), and/or trader limit price, the trading system will route and display the IOI message to the trader UI.

As shown, the IOI data component 604 presents IOIs 610-1 through 610-3 with trade data that matches blotter data of the blotter data component 602. That is, the logic used to filter IOI messages is configured based on the blotter data. Hence, the trader's interest in an IOI is inferred from the content of the blotter data component 602. The IOI messages 610 are associated with actionable controls 612 including a “firm up” button and a “decline all” button. Clicking on the firm up button will trigger an execution on the selected IOI message 610-2 and automatically send a message back to the broker system to indicate the execution. Thus, the user's trading activity is used to infer the user's interests, which are used to program logic that filters IOIs.

An IOI message can include a combination of one or more standardized tags that are added by the broker system and used to process the IOI message with the system logic. The tags and associated attributes (e.g., values) are processed by the logic of the intermediary system to route IOI messages to client systems for traders that have identifiable interests matching the IOIs. For example, the broker system can choose from a menu of different classes of tags and set attributes for an IOI message. An example of a class of tags includes routing tags (e.g., route type tag, route ID tag). Another class of tags includes qualifier tags that indicate whether and how an IOI is qualified. Examples of qualifiers include client interests (e.g., block, allow) or broker interests (e.g., unwind, position wanted, market making). A qualifier tag can have attributes and values related to price, pegging, and execution instructions. In yet another example, a tag indicates a conditional or firm IOI message. A tag can include default attributes.

At 506, the intermediary system receives an indication of an action at the client system to execute on the IOI message (e.g., firm-up). In one implementation, the trader can actuate a control associated with a selected IOI message. For example, as shown in FIG. 6, the IOI message function is integrated into an OMS to present IOI messages 610-1 through 610-3 of interest to the trader based on the financial data included in the blotter data component 602. The trader can click on the firm up button of the controls 612 to accept the offer of the selected IOI message 610-2.

At 508, in response to receiving an indication of the action triggered at the client system to execute the IOI, the intermediary system sends a placement request to the OMS to commit to the trade of the IOI. For example, the intermediary system can send a placement request to trade 5,000,000 shares of the security indicated in the selected IOI message 610-2. The placement request causes the OMS to commit the 5,000,000 shares and avoids over-execution of the trade. At 510, the intermediary system receives an acknowledgement from the OMS in response to the placement request.

At 512, when the IOI message is a conditional IOI message, the intermediary system sends an invitation to the broker system to commit to the trade of the IOI. At 514, the broker system responds by sending a message to commit to the trade indicated in the IOI. In other words, the broker is told that the offer has been accepted and the broker firms up to commit to the trade. The invitation at 512 and response at 514 are omitted when the IOI is a firm order, because the broker system committed to the trade unconditionally. Lastly, at 516, the intermediary system causes the broker system, client system, and OMS to fill the order of the trade.

The disclosed technology can include variations and enhancements to the described examples. For example, an OMS can enable creating a dummy entry in a blotter to sweep in desired IOIs or enable entering symbols of interest in an area of a trader UI other than the blotter. In another example, the intermediary system implements machine learning techniques to develop rules based on historical trading activity among traders, regardless of what is on their blotter. As such, a user can simply “opt in” to IOI filtering that is based on artificial intelligence techniques to receive the benefits of the disclosed technology. Moreover, the communications can occur in real-time or near real-time and with entities not shown in FIG. 5. For example, the broker system can receive an indication of an execution in real-time and relay the indication to a client that sponsored the trade.

In some implementations, the intermediary system supports executions of IOIs outside the NBBO pricing or price protection conditions of an order and is responsible for the Order Protection Rule (OPR) obligation. If an IOI is to execute outside the NBBO, the OPR rule mandates that the trading system must sweep (execute against) the top of book of all protected displayed markets in the US. As such, for example, executions may be for less than a traded volume. The minimum requirements for a broker to use this function include that the broker must be a live sponsor on the intermediary system, must populate capacity on an inbound IOI message, and must describe the IOI using at least one of a set of tags.

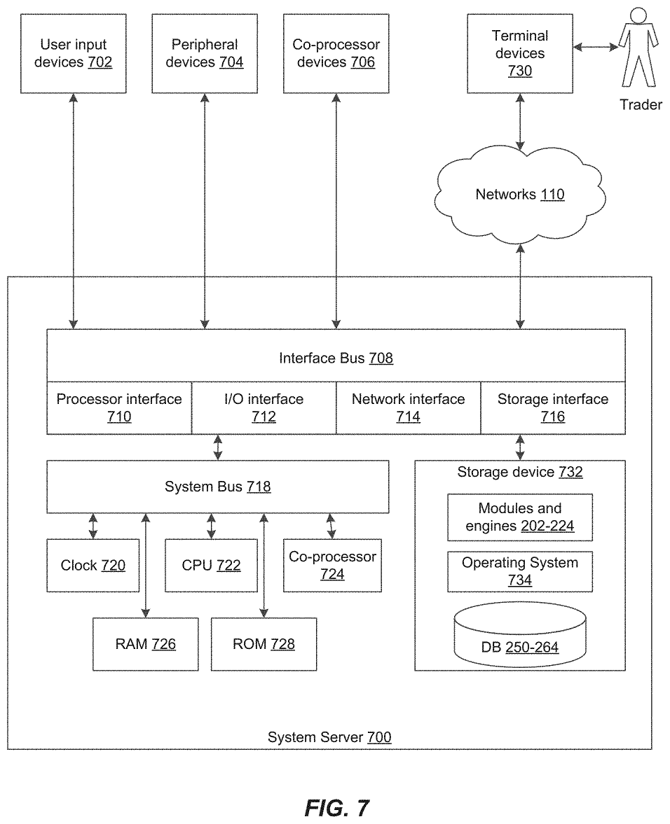

FIG. 7 is a block diagram of an example machine implementing a system for processing IOIs communicated between users of an electronic trading platform. Aspects and implementations have been described in the general context of computer-executable instructions, such as routines executed by a general-purpose computer, a personal computer, a server, and/or other computing systems such as a system server 700 (e.g., system server 126. The system server 700 can communicate with entities including one or more users (e.g., traders), client/terminal devices 730, user input devices 702, peripheral devices 704, and an optional co-processor device(s) (e.g., cryptographic processor devices) 706. Users can engage with the system server 700 via client devices 730 over the networks 110.

Computers employ a central processing unit (CPU) or processor (hereinafter “processor”) to process information. Processors may include programmable general-purpose or special-purpose microprocessors, programmable controllers, application-specific integrated circuits (ASICs), programmable logic devices (PLDs), embedded components, or combination of such devices. Processors execute program components in response to user and/or system-generated requests. These components may be implemented in software, hardware or both hardware and software. Processors pass instructions (e.g., operational and data instructions) to enable various operations.

The system server 700 includes clock 720, CPU 722, memory such as read only memory (ROM) 728 and random access memory (RAM) 726 and co-processor 724. These components are connected to a system bus 718, and through the system bus 718 to an interface bus 708. Further, user input devices 702, peripheral devices 704, co-processor devices 706, and the like, are connected through the interface bus 708 to the system bus 718. The Interface bus 708 may be connected to a number of interface adapters such as processor interface 710, input output interfaces (I/O) 712, network interfaces 714, storage interfaces 716, and the like.

The processor interface 710 may facilitate communication between the co-processor devices 706 and the co-processor 724. In one implementation, the processor interface 710 may expedite encryption and decryption of requests or data. Input/Output interfaces (I/O) 712 facilitate communication between user the input devices 702, the peripheral devices 704, the co-processor devices 706, and/or the like and components of the system server 700 using protocols such as those for handling audio, data, video interface, wireless transceivers, or the like (e.g., Bluetooth, IEEE 1394a-b, serial, universal serial bus (USB), Digital Visual Interface (DVI), 802.11 a/b/g/n/x, cellular).

Network interfaces 714 may be in communication with the network. Through the network, the trading system server may be accessible to remote client devices. The network interfaces 714 may use various wired and wireless connection protocols such as, direct connect, Ethernet, wireless connection such as IEEE 802.11a-x, and the like. Examples of the networks 110 include the Internet, Local Area Network (LAN), Metropolitan Area Network (MAN), a Wide Area Network (WAN), wireless network (e.g., using Wireless Application Protocol WAP), a secured custom connection, and the like. The network interfaces 714 can include a firewall which can, in some embodiments, govern and/or manage permission to access/proxy data in a computer network, and track varying levels of trust between different machines and/or applications.

The firewall can include any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand. Other network security functions performed or included in the functions of the firewall, can be, for example, but are not limited to, intrusion-prevention, intrusion detection, next-generation firewall, personal firewall, without deviating from this disclosure.

The storage interfaces 716 may be in communication with a number of storage devices such as, storage devices 732, removable disc devices, and the like. The storage interfaces 716 may use various connection protocols such as Serial Advanced Technology Attachment (SATA), IEEE 1394, Ethernet, Universal Serial Bus (USB), and the like.

The user input devices 702 and the peripheral devices 704 can connect to the I/O interface 712 and potentially other interfaces, buses, and/or components. The user input devices 702 may include card readers, finger print readers, joysticks, keyboards, microphones, mouse, remote controls, retina readers, touch screens, sensors, and/or the like. The peripheral devices 704 may include antenna, audio devices (e.g., microphone, speakers, etc.), cameras, external processors, communication devices, radio frequency identifiers (RFIDs), scanners, printers, storage devices, transceivers, and/or the like. The co-processor devices 706 may be connected to the system server 700 through the interface bus 708, and can include microcontrollers, processors, interfaces or other devices.

Computer executable instructions and data may be stored in memory (e.g., registers, cache memory, random access memory, flash) which are accessible by processors. These stored instruction codes (e.g., programs) can engage processor components, motherboard and/or other system components to perform desired operations. The system server 700 may employ various forms of memory including on-chip CPU memory (e.g., registers), RAM 726, ROM 728, and storage devices 732. The storage devices 732 may employ any number of tangible non-transitory storage devices or systems such as fixed or removable magnetic disk drive, an optical drive, solid state memory devices and other processor-readable storage media.

Computer-executable instructions stored in the memory may include the system 200 having one or more program modules such as routines, programs, objects, components, data structures, and so on that perform particular tasks or implement particular abstract data types. For example, the memory may contain operating system (OS) component 734, program modules and other components (e.g., 202-224), database tables 250-264, and the like. These modules/components may be stored and accessed from the storage devices, including from external storage devices accessible through an interface bus.

The database components 250-264 are stored programs executed by the processor to process the stored data. The database components may be implemented in the form of a database that is relational, scalable and secure. Examples of such database include DB2, MySOL, Oracle, Sybase, and the like. Alternatively, the database may be implemented using various standard data-structures, such as an array, hash, list, struct, structured text file (e.g., XML), table, and/or the like. Such data-structures may be stored in memory and/or in structured files.

The system server 700 may be implemented in distributed computing environments, where tasks or modules are performed by remote processing devices, which are linked through a communications network, such as a Local Area Network (“LAN”), Wide Area Network (“WAN”), the Internet, and the like. In a distributed computing environment, program modules or subroutines may be located in both local and remote memory storage devices. Distributed computing may be employed to load balance and/or aggregate resources for processing. Alternatively, aspects of the system server 700 may be distributed electronically over the Internet or over other networks (including wireless networks). Those skilled in the relevant art will recognize that portions of the system 200 may reside on a system server 700, while corresponding portions reside on a client computer. Data structures and transmission of data particular to aspects of the system server 700 are also encompassed within the scope of the embodiments.

The above Detailed Description of embodiments of the disclosure is not intended to be exhaustive or to limit the disclosed system and methods to the precise form disclosed above. While specific examples for the embodiments are described above for illustrative purposes, various equivalent modifications are possible within the scope of the embodiments, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative combinations or sub-combinations. Each of these processes or blocks may be implemented in a variety of different ways. Also, while processes or blocks are at times shown as being performed in series, these processes or blocks may instead be performed or implemented in parallel, or may be performed at different times.

Some portions of the disclosure can be presented in terms of algorithms and symbolic representations of operations on data bits within a computer memory. These algorithmic descriptions and representations are the means used by those skilled in the data processing arts to most effectively convey the substance of their work to others skilled in the art. An algorithm can refer to a sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” “computing,” “calculating,” “determining,” “displaying,” “generating,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems can be used with programs in accordance with the described teachings, or it can prove convenient to construct more specialized apparatus to perform the methods of some implementations. The required structure for a variety of these systems will appear from the description. In addition, the techniques are not described with reference to any particular programming language, and various implementations can thus be implemented using a variety of programming languages.

In some circumstances, operation of a memory device, such as a change in state from a binary one to a binary zero or vice-versa, for example, can comprise a transformation, such as a physical transformation. With particular types of memory devices, such a physical transformation can comprise a physical transformation of an article to a different state or thing, For example, but without limitation, for some types of memory devices, a change in state can involve an accumulation and storage of charge or a release of stored charge. Likewise, in other memory devices, a change of state can comprise a physical change or transformation in magnetic orientation or a physical change or transformation in molecular structure, such as from crystalline to amorphous or vice versa. The foregoing is not intended to be an exhaustive list in which a change in state for a binary one to a binary zero or vice-versa in a memory device can comprise a transformation, such as a physical transformation. Rather, the foregoing is intended as illustrative examples.

### Remarks

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

In general, the terms used in the following claims should not be construed to limit the disclosure to the specific examples disclosed in the specification, unless the above Detailed Description section explicitly defines such terms. Accordingly, the actual scope of the disclosure encompasses not only the disclosed examples, but also all equivalent ways of practicing or implementing the disclosure under the claims.

From the foregoing, it will be appreciated that specific embodiments of the disclosure have been described herein for purposes of illustration, but that various modifications may be made without deviating from the spirit and scope of the disclosure. Accordingly, the disclosure is not limited.

We claim:

1. At least one computer-readable storage medium, excluding transitory signals and carrying instructions, which, when executed by at least one processor, cause an intermediary system to:
receive, from a broker system, an electronic message including an indication of interest (IOI) to execute a trade of a security;
identify an interest of a trader in the trade of the security indicated in the IOI based on trader activity data of the trader,
wherein the trader activity data includes blotter data of the trader collected from a trading platform,
wherein the identified interest of the trader is inferred based on the blotter data and is distinct from the IOI of the security, and
wherein the identified interest of the trader is undisclosed by the trader to the broker system and to the intermediary system;
route the electronic message including the IOI to a client system of the trader with the identified interest in the trade of the security;
receive an indication that the trader performed an action at the client system to execute the trade of the security in response to the IOI; and
cause the broker system and the client system to fill an order of the trade.

2. The at least one computer-readable storage medium of claim 1, wherein the IOI is conditioned on the broker system committing to the trade after the client system indicates that the trader committed to the trade.

3. The at least one computer-readable storage medium of claim 1, wherein the intermediary system is further caused to, prior to causing to fill the order:
send a placement request for the order of the trade to an order management system (OMS) of the trader,
wherein the order is filled in part with the OMS.

4. The at least one computer-readable storage medium of claim 1, wherein the identified interest of the trader is based on a pattern of trade entries in the blotter data.

5. The at least one computer-readable storage medium of claim 1, wherein the identified interest of the trader is based on an entry of an active trade in a blotter of the trader.

6. The at least one computer-readable storage medium of claim 1, wherein the identified interest of the trader is based on an entry of an inactive trade in a blotter of the trader.

7. The at least one computer-readable storage medium of claim 1, wherein the intermediary system is further caused to:
receive, from the broker system, multiple electronic messages including respective IOIs; and
identify interests of multiple traders in trades indicated by the respective IOIs;
wherein identified interests are inferred based on trading activities of the traders, and
wherein identified interests are undisclosed by the multiple traders to the broker system and to the intermediary system; and
filter the multiple electronic messages based on the identified interests of the multiple traders such that only client systems of particular traders with identified interests in particular IOIs are designated to receive the IOIs.

8. The at least one computer-readable storage medium of claim 1, wherein the intermediary system is further caused to:
receive, from the broker system, multiple electronic messages including respective IOIs; and
filter the multiple electronic messages based on logic configured to match the IOIs with traders having corresponding interests in trades of the IOIs.

9. The at least one computer-readable storage medium of claim 1, wherein the indication of the action at the client system includes an indication that a graphical control was actuated on a user interface to execute the trade, and wherein the graphical control is presented concurrently with the IOI.

10. The at least one computer-readable storage medium of claim 1, wherein the intermediary system is further caused to, prior to causing to fill the order:
receive, from the broker system, a list of clients that are targeted to receive copies of the electronic message; and
select the trader from among the list of clients that are targeted to receive the electronic message.

11. The at least one computer-readable storage medium of claim 1, wherein the electronic message includes a tag, and the intermediary system is further caused to, prior to causing to fill the order:
select the trader based on an attribute of the tag matching an attribute of the trader.

12. The at least one computer-readable storage medium of claim 1, wherein the intermediary system is further caused to:
receive, from the broker system, multiple electronic messages including respective IOIs; and
filter the multiple electronic messages based on a set of global rules configured to match a particular electronic message with a particular identified interest of a particular trader,
wherein the set of global rules limits recipients of a broker's IOI only to the broker's clients, and limits receipt of an IOI only to recipients that permit receipt of the IOI.

13. The at least one computer-readable storage medium of claim 1, wherein the intermediary system is further caused to:
receive, from the broker system, multiple electronic messages including respective IOIs; and
filter the multiple electronic messages based on a preference for routing a particular IOI to a particular trader having a particular interest in the particular IOI,
wherein the preference is for any IOI including a trade that mirrors an active trade or an inactive trade or both in the particular trader's blotter.

14. The at least one computer-readable storage medium of claim 1, wherein the intermediary system is further caused to:
filter multiple electronic messages based on scores determined for traders of client systems,
wherein only particular traders that meet or exceed a threshold score are permitted to receive the filtered electronic messages; and
wherein the scores are determined based on historical data indicative of a quantity of instances or an amount of time spent viewing IOIs.

15. A system comprising:
at least one processor; and
at least one non-transitory memory storing instructions, which, when executed by the at least one processor, cause the system to:
process multiple indications of interest (IOIs) based on system logic to identify one or more traders that have interests in trades of the multiple IOIs,
wherein the system logic includes a rule that applies to any IOIs and a user rule that indicates a preference of a client or a broker;
match a particular IOI with a particular trader that has an identified interest in a particular trade of the particular IOI;
route the particular IOI toward a client system of the particular trader that has the identified interest in receiving the particular IOI; and
execute the particular trade based on an indication of an action triggered at the client system in response to the particular IOI.

16. The system of claim 15, wherein the particular trader is a first trader, and the system is further caused to:
determine that a second trader does not have an identified interest in the particular trade of the particular IOI; and
block disclosure of the particular IOI to the second trader.

17. The system of claim 15, wherein the identified interest is based on blotter data of the particular trader matching trade data of the IOI.

18. A method performed by a system in a trading environment, the method comprising:
receiving (i) an indication of interest (IOI) to execute a trade and (ii) a list of traders indicated as recipients of the IOI;
routing an electronic message including the IOI to a first client system of a first trader having an identified interest in the IOI; and
blocking a second client system of a second trader without an identified interest in the IOI from receiving the IOI,
wherein an interest in the IOI is inferred based on blotter data for a respective trader matching trade data of the IOI.

19. The method of claim 18 further comprising:
causing a display device of the first client system to present the IOI concurrently with blotter entries in a common user interface.

20. The method of claim 18 further comprising:
conditioning the IOI on a broker committing to the trade after the first trader commits to the trade.
